(19) United States
(12) Patent Application Publication
(10) Pub. No.: US 2020/0070978 A1
(43) Pub. Date: Mar. 5, 2020

(54) Concentric pump spray system

(71) Applicant: Skypath, LLC, Cape Coral, FL (US)

(72) Inventors: Nicole Williams, Cape Coral, FL (US); Lydia Williams, Cape Coral, FL (US); Richard Howe, Cape Coral, FL (US)

(21) Appl. No.: 16/115,645

(22) Filed: Aug. 29, 2018

(51) Int. Cl. B64D 1/18; B05B 9/04

(52) U.S. Cl. CPC B64D 1/18; A01C 23/047; B05B 9/0403

(57) ABSTRACT

The leak-proof chemical distribution system is a spray system for mounting on a vehicle, such as a truck or aircraft, for the distribution of chemicals.

The system is separated into a storage section and a distribution section.

The storage section is located within the vehicle, and thus must be leakproof. The distribution section is located outside the vehicle, thus any connections or components that may leak will not leak on the vehicle.

### FIELD

This invention relates to the field of chemical distribution and more particularly to a device for spraying chemicals while avoiding damage to the vehicle bearing the device.

### BACKGROUND

The distribution of chemicals is critical to modern agriculture for fertilizing crops and controlling pests. Beyond agriculture, chemical distribution is used to control mosquito populations and the associated spread of disease.

To perform this chemical distribution efficiently, a system must be able to distribute chemicals across large physical areas. Spray systems are a practical and efficient means of performing this work. A spray system is often vehicle-mounted to permit a large, heavy system to be transported.

The problem with mounting the spray system to a vehicle is the resulting exposure of the vehicle to the chemical. The chemicals are often highly concentrated corrosive acids. The corrosive action is strong enough to affect materials that are considered resistant to corrosion, such as stainless steel.

Given that metal construction is common for vehicles, any exposure of the vehicle to corrosive chemicals creates a safety hazard to the vehicle operator.

What is needed is a chemical distribution system that cannot leak inside the vehicle, either during storage or during operation.

### SUMMARY

The leak-proof chemical distribution system is a spray system for mounting on a vehicle, such as a truck or aircraft, for the distribution of chemicals.

The system is separated into a storage section and a distribution section.

Note that within this application the term “line” or “lines” refers to piping or tubing used to transport liquids, such as chemicals.

The storage section is located within the vehicle, and thus must be leakproof. The distribution section is located outside the vehicle, thus any connections or components that may leak will not leak on the vehicle.

The storage section employs multiple strategies to eliminate the chance of leaking.

First, all penetrations and connections are above the chemical level within the storage tank. Thus, when the system is inactive, gravity pulls chemical away from the connections and leaks are avoided.

Second, when the system is active, the tubing and piping lines leading to the one or more pumps operate under negative pressure with respect to the atmosphere.

As explained below, the pump is downstream of the storage system. Given that the storage system is upstream, during use the chemical is pulled from the storage system, resulting in negative pressure within the upstream tubing and piping. Thus, if connections or lines leak, the leak will be of air into the lines, rather than the chemical out of the lines.

Turning to the distribution system, the associate components are outside the bounds of the vehicle. While leaks are still disfavored, if a leak within the distribution system occurs the chemical will not contact the vehicle.

After chemical distribution is complete or the storage tank is empty, the lines are flushed with a rinse solution to displace any remaining chemical, thereby reducing the possibility of damage due to chemical leakage.

Turning to the components of the storage system, the primary parts are a storage tank and a flush tank.

Both tanks use only top penetrations to prevent leakage from tank connections. Each line that exits a tank does so through a riser, the riser descending into the tank and terminating at or near the tank bottom.

Each tank includes an optional access port for inspection and cleaning.

The storage tank includes a connection to a loading line for filling. The loading line optionally connects to a riser. The flush tank optionally includes a connection to a loading line for filling with rinse solution, the loading line to the flush tank open during filling but otherwise closed.

The storage tank preferably includes multiple discharge lines. Each discharge line has a shutoff valve that isolates the line from the storage tank. Downstream of the shutoff valve is a bypass valve. During normal operation, the shutoff valve is in an open position, and the bypass valve is in a first position that allows liquid to flow from the storage tank pump. During a flush, the shutoff valve is in a closed position and the bypass valve is in a second position, isolating the storage tank and instead drawing liquid from the flush tank.

The flush draws liquid from the flush tank, through the outlet lines, through the distribution system, and out through the nozzles.

The motivating force for the distribution of the chemical is the pump. The pump is preferably a high-pressure, concentric model, such as a hydraulic gear pump. In other embodiments, a different type of pump is used.

A concentric pump is a gear pump consisting of two gears. As one gear is driven, its opposing gear is driven. Both gears are contained within a housing which turns the rotational motion of the gears into a pump.

Concentric pumps are ideal for the disclosed pesticide spray system because the pump can self-prime. The use of a self-priming pump allows the use of top connections from the storage and flush tanks, thereby avoiding the risk of leaking from lower connections. Thus, the pump may begin operation without a working fluid, and instead can draw fluid up and out of the storage or flush tanks

Fittings located below the resting chemical level of either tank create a risk of leakage driven by gravity.

To date, concentric pumps have not been used in chemical spraying operations, instead limited to use with hydraulic fluid.

As an example of appropriate concentric pumps, the following table includes acceptable models from Haldex:

| | Displacement | | | Maximum | Maximum | |
|---|---|---|---|---|---|---|
| | in cubic inch | GPM | | continuous | intermittent | |
| Model | per | Flow at | GPM Flow | pressure | pressure in | |
| Number | revolution | 1800 RPM | at 3600 RPM | in psi | psi | Port Size |
| 10561 | 0.065 | 0.5 | 1 | 3000 | 4000 | 9/16-18 |
| | | | | | | SAE #6 |
| 10562 | 0.097 | 0.75 | 1.5 | 3000 | 4000 | 9/16-18 |
| | | | | | | SAE #6 |
| 10563 | 0.129 | 1 | 2 | 3000 | 4000 | 3/4-16 |
| | | | | | | SAE #8 |
| 10564 | 0.194 | 1.5 | 3 | 3000 | 4000 | 3/4-16 |
| | | | | | | SAE #8 |
| 10565 | 0.258 | 2 | 4 | 2300 | 4000 | 3/4-16 |
| | | | | | | SAE #8 |
| 10566 | 0.388 | 3 | 6 | 1600 | 2500 | 7/8-14 |
| | | | | | | SAE #10 |
| 10567 | 0.517 | 4 | 8 | 1200 | 2000 | 7/8-14 |
| | | | | | | SAE #10 |

While the pump models in the table above operate up to 4,000 psi, pump pressures of up to 50,000 psi are possible.

The preferred nozzle has a demonstrated ability to achieve an optimum droplet size of 8 microns, using an orifice size of 0.008 of an inch.

The pump is shaft driven, thereby permitting rotational energy from the preferable source of a propeller, but also permitting other sources of rotational energy. Examples include electric motors, gasoline engines, hydraulic motors, air motors, and so forth.

In the preferred embodiment, the shaft of the pump is connected to the propeller. The forward motion of the vehicle causes the motion of air through the propeller that operates the pump. The use of a propeller powered by motion of the vehicle results in automatic adjustment of chemical application based on vehicle speed. As the vehicle speed increases, rotation of the propeller increases, and dispensing quantity increase. This occurs correspondingly as vehicle speed slows.

After being pressurized by the pump, the chemical is routed to one or more nozzles. Preferably multiple nozzles are used, arranged in an array. The use of an array of nozzles distributes the chemical through the air, allowing for effective mixing.

The preferred embodiment for the chosen application requirements is a nozzle array of eighteen nozzles arranged in groups of three. But other nozzle quantities and arrangements are possible.

Turning to the individual nozzles, the ideal construction is unique as compared to stock nozzles.

The chemicals used in certain applications, such as certain pesticides, are highly corrosive. Combined with the high application pressures, many materials are unable to withstand operation.

Thus, stock nozzles are modified. If an internal screen exists within the nozzle, it is removed. The removal of the screen permits smooth flow of chemical to the discharge orifice.

The stock filter is replaced with a polypropylene filter that is sufficiently strong to withstand the operating pressures, while of a fine enough filter to catch any materials that may clog the discharge orifice.

Turning to the structure, the pump, propeller, nozzles, and associated elements are held away from the vehicle. Support is preferably provided by a box beam or other structural support. Such cross-sections are ideal as lines can be run within the beam where it is protected.

Lines run through box beam, then exits through one or more penetrations.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a view of a first embodiment mounted on a vehicle.

FIG. 2 illustrates a front view of the dispersal section of the first embodiment.

FIG. 3 illustrates a rear view of the dispersal section of the first embodiment.

FIG. 4 illustrates a nozzle array of the first embodiment.

FIG. 5 illustrates a view of a storage section of the first embodiment.

FIG. 6 illustrates a close-up view of the storage section of the first embodiment.

FIG. 7 illustrates a sample nozzle.

FIG. 8 illustrates the sample nozzle with a filter installed.

FIG. 9 is a Process and Instrumentation Diagram (“P&ID”) of the first embodiment.

### DETAILED DESCRIPTION

Reference will now be made in detail to embodiments of the invention, examples of which are illustrated in the accompanying drawings. Throughout the following detailed description, the same reference numerals refer to the same elements in all figures.

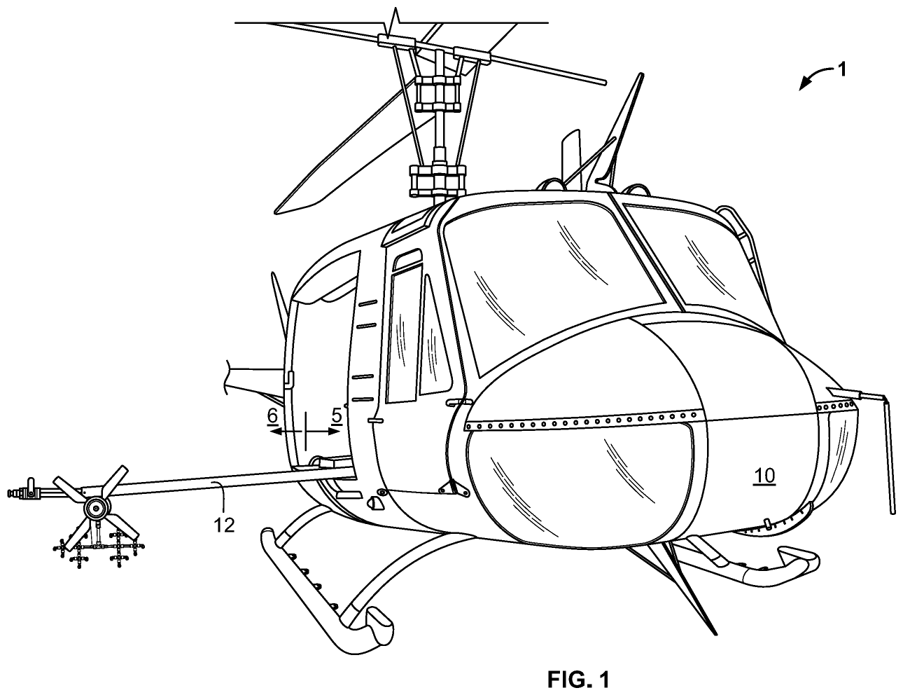

Referring to FIG. 1, a view of a first embodiment mounted on a vehicle is shown.

The spray system 1 is shown, including vehicle 10. The example vehicle 10 is a helicopter, but other vehicles, from autonomous aircraft referred to as “drones,” to trucks and airplanes, are all options.

A box beam 12 protrudes from the vehicle 10, with the internal portion of the vehicle 10 comprising the storage section 5 and the external portion comprising the dispersal section 6.

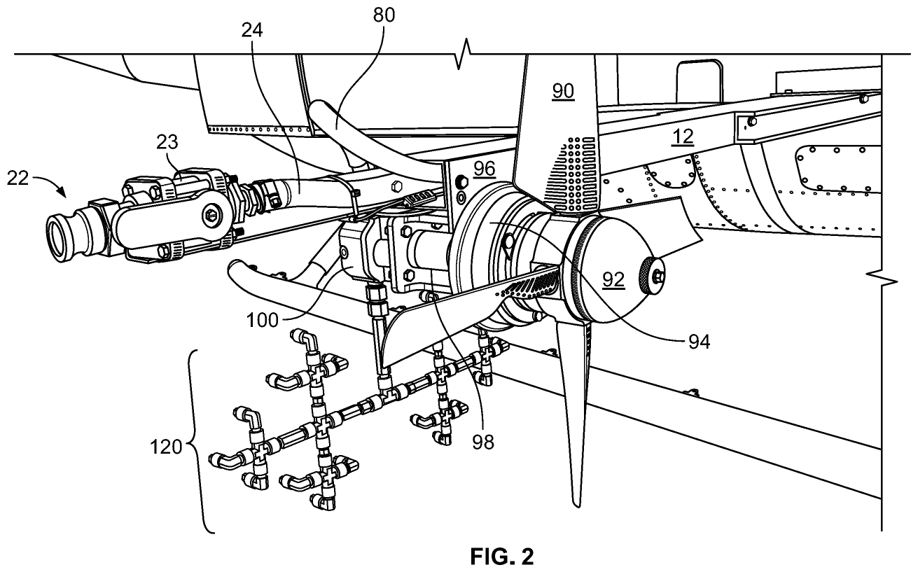

Referring to FIG. 2, a front view of the dispersal section of the first embodiment is shown.

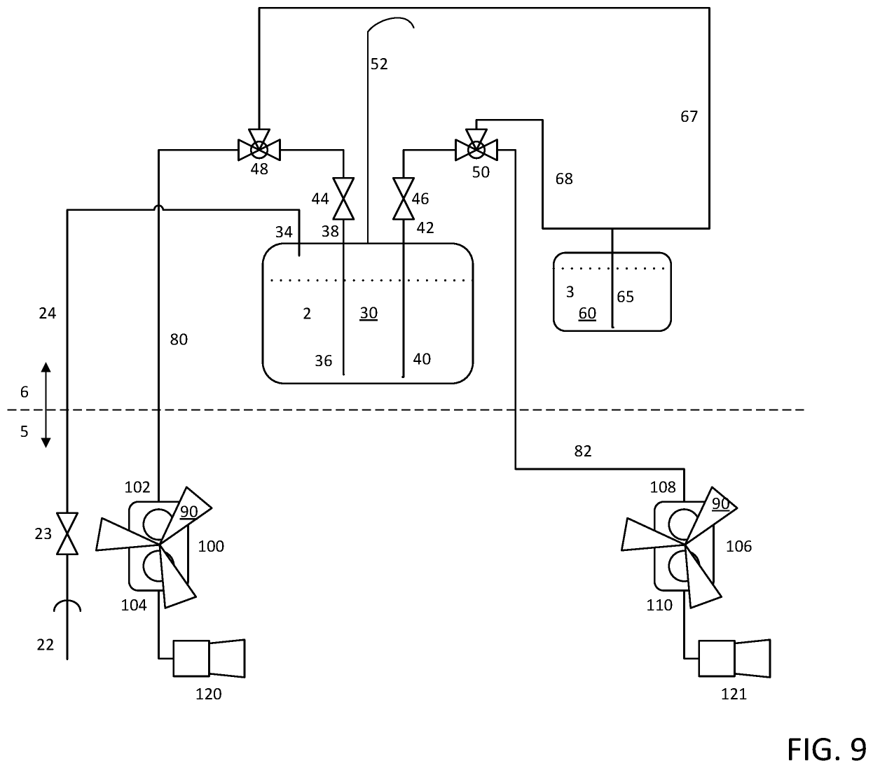

Chemical 2 (see FIG. 9) is loaded into the spray system 1 (see FIG. 1) by connecting a hose to the fill hose connection 22. The fill hose valve 23 is opened to permit chemical 2 (see FIG. 9) to pass, and flow through inlet line 24, which passes through box beam 12.

Mounted to the end of box beam 12 is mounting plate 96, which supports bearing 94. Bearing 94 permits rotation of propeller 90 with respect to box beam 12. Joining the propeller 90 to a pump, here first pump 100, is coupling 98. The propeller 90 includes optional hub 92.

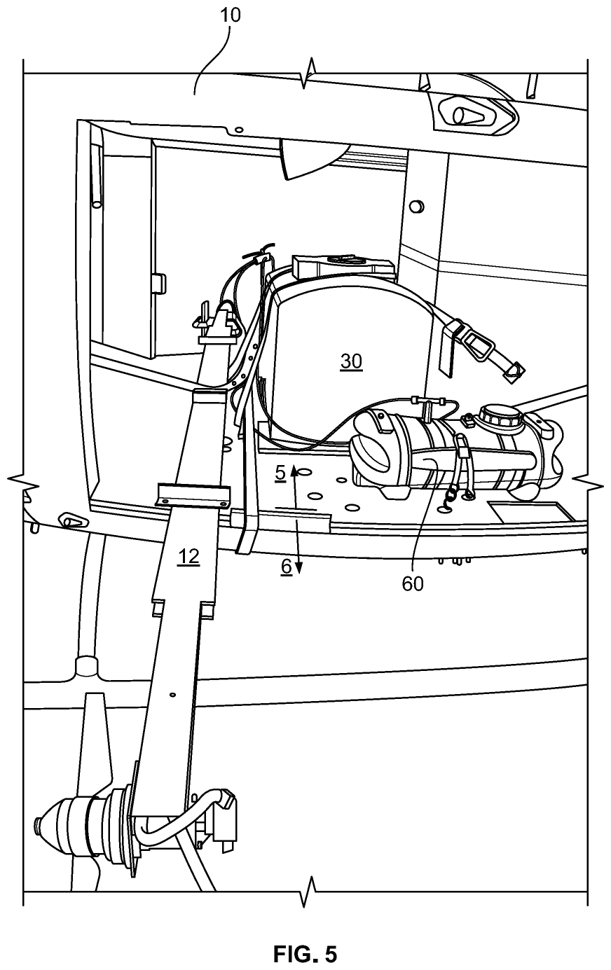

The first pump inlet line 80 carries chemical 2 (see FIG. 9) from the storage tank 30 (see FIG. 5) to the first pump 100.

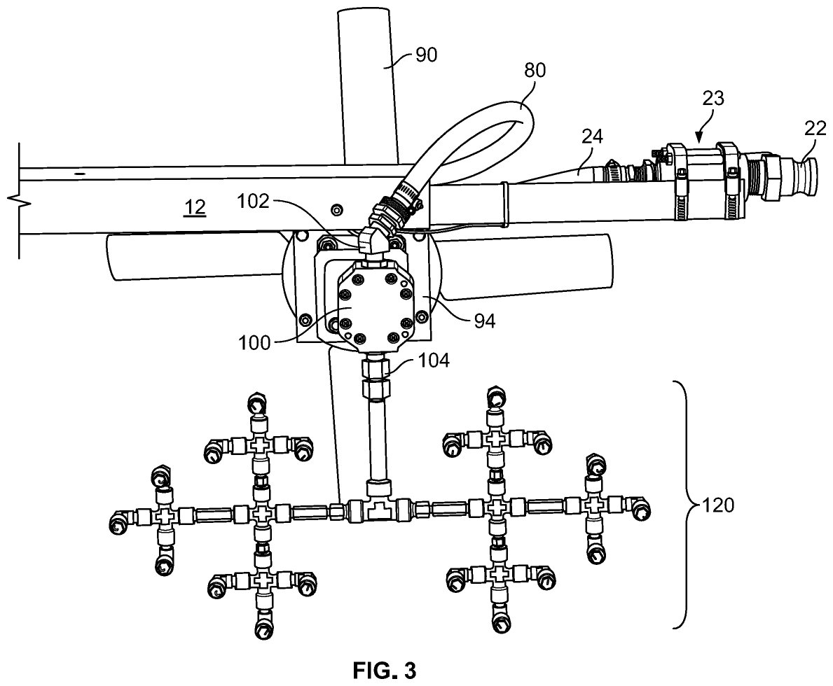

Referring to FIG. 3, a rear view of the dispersal section of the first embodiment is shown.

The box beam 12 again supports the bearing 94, with the rear of propeller 90 visible. The first pump 100 is shown connected to the first pump inlet line 80 at first pump inlet 102.

The first pump discharge 104 flows to first nozzle array 120, after which chemical 2 (see FIG. 9) is distributed into the air.

Again shown is fill hose connection 22 with fill hose valve 23 flowing into inlet line 24.

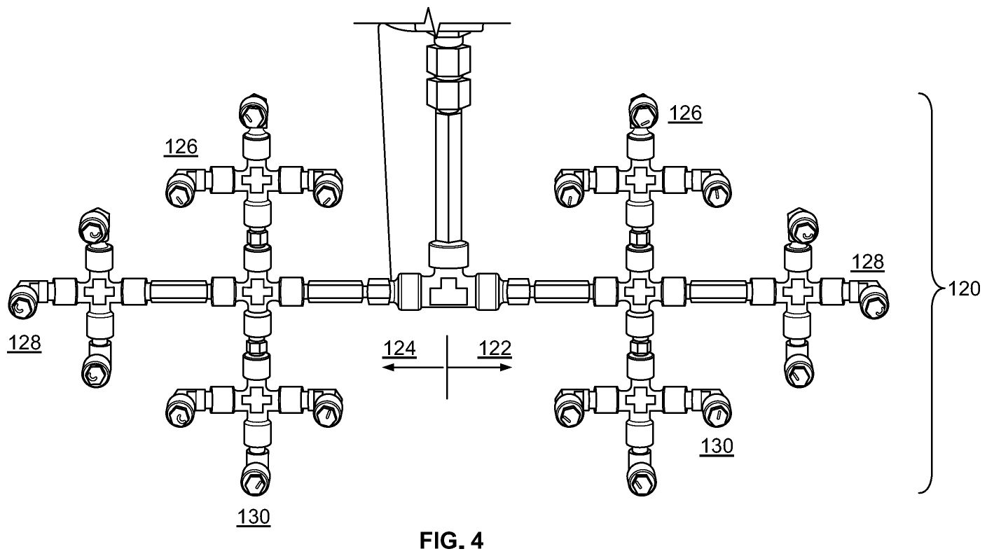

Referring to FIG. 4, first nozzle array 120 of the first embodiment is shown.

The first nozzle array 120 is divided into an outer nozzle section 122 and an inner nozzle section 124—inner being toward the vehicle 10 (see FIG. 1) and outer being away from the vehicle 10.

The sections are divided into upper nozzle groups 126, middle nozzle groups 128, and lower nozzle groups 130.

Arranging the nozzles 140 in groups, as illustrated, results in equal pressure at each nozzle 140. By equalizing the pressure drop between the first pump discharge 104 and each individual nozzle 140, each nozzle 140 performs identically and optimally.

Referring to FIG. 5, a view of a storage section 5 of the first embodiment is shown.

Box beam 12 passes into vehicle 10, the edge of vehicle 10 delineating storage section 5 from dispersal section 6. As discussed above, the storage section 5 lies within the vehicle 10, and thus must include only components that are leak-proof. Or, if not leak-proof, the components within the storage section 5 must operate under negative pressure and thus may leak air in, but not chemical 2 (see FIG. 9) out.

Further shown is storage tank 30 and flush tank 60.

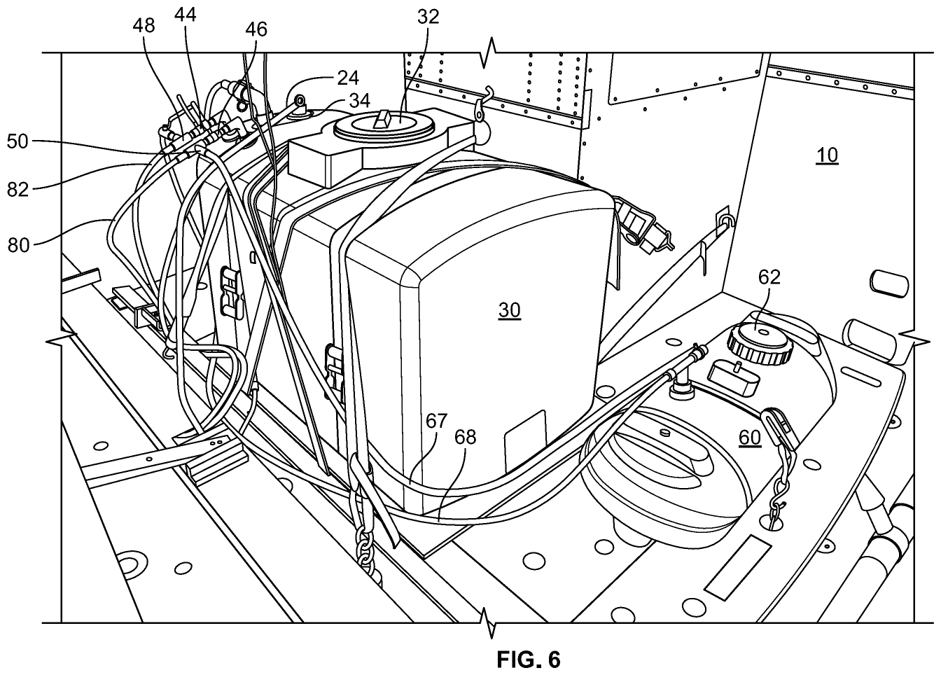

Referring to FIG. 6, a close-up view of the storage section 5 of the first embodiment is shown.

Storage tank 30 optionally includes access port 32 for cleaning and maintenance.

During filling, chemical 2 (see FIG. 9) flows through inlet line 24 to storage tank loading inlet 34.

During chemical dispersal, the first outlet block valve 44 leads to the dispersal equipment on one side of the vehicle 10, and second outlet block valve 46 to the other side. Chemical 2 (see FIG. 9) flows from the storage tank 30, through the respective block valves 44/46, and to the first pump inlet line 80 and second pump inlet line 82.

During flushing, the first outlet bypass valve 48 and second outlet bypass valve 50 are used to switch the active lines from the storage tank 30 to the flush tank 62. The first outlet block valve 44 and second outlet block valve 46 are closed to isolate the storage tank 30. The result is that the first pump 100 and second pump 106 intake from the flush tank 60, rather than the storage tank 30. Thus, rinse solution 3 (See FIG. 9) flows from flush tank 60, through first flush line 67 and second flush line 68.

The flush tank 60 is shown with access port 62 for maintenance and cleaning.

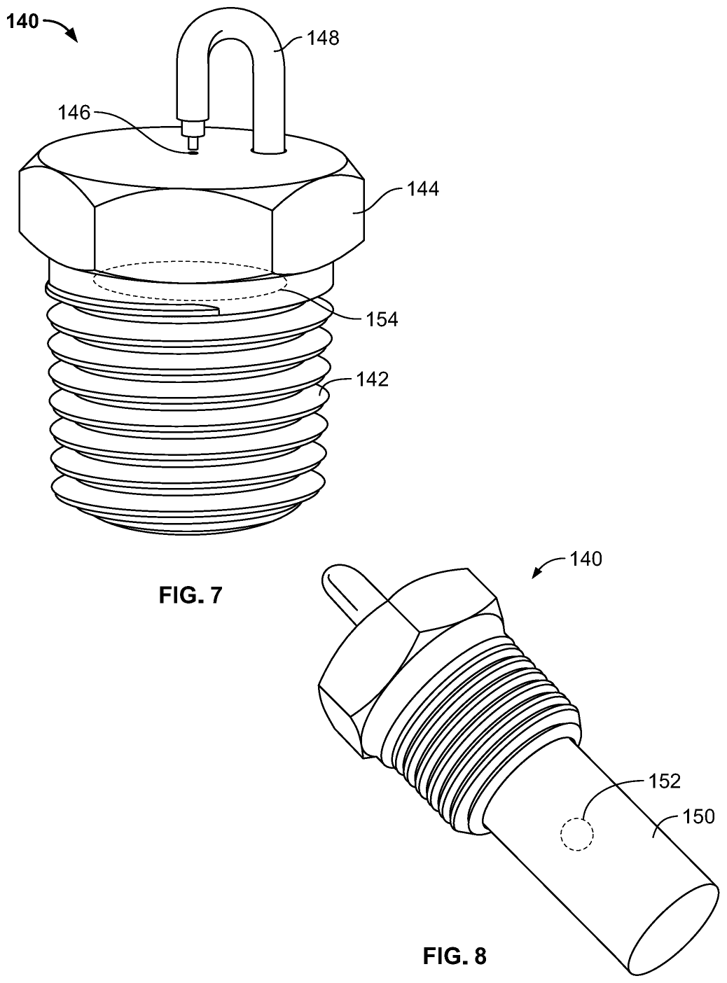

Referring to FIG. 7, a first embodiment of a nozzle 140 is shown.

Nozzle 140 includes a section with threads 142 topped by a head 144. The penetration within the head 144 is the discharge orifice 146. Fluid exiting the discharge orifice 146 contacts the distributor 148, which breaks the stream of fluid into an aerosol, thereby distributing the fluid.

Within the body of the nozzle 140 is an optional mesh screen 154. In the preferred embodiment this screen 154 is removed, because the mesh screen 154 cannot withstand the common highly corrosive chemical corrosion and thus often quickly corrodes, melts, and/or fills with particulates, which in turn clog the discharge orifice 146.While the illustrated nozzle 140 is preferred, alternative nozzle designs may produce the preferred discharge droplet size of eight microns.

Referring to FIG. 8, the sample nozzle 140 with a polypropylene filter 152 installed is shown.

Nozzle 140 includes an optional filter 150. The stock filter 150 may include a filter penetration 152.

The preferred embodiment of filter 150 lacks the filter penetration 152 and is instead formed from a continuous material.

Referring to FIG. 9, a Process and Instrumentation Diagram (“P&ID”) of the first embodiment is shown.

During loading, chemical 2 is pumped into fill hose connection 22 through fill hose valve 23, down inlet line 24, and into the storage tank loading inlet 34. The storage tank 30 fills, with any trapped air or vapors vented to atmosphere through the storage tank vent line 52.

During a normal dispersal operation, chemical 2 from storage tank 30 passes to one or both of the dispersal portions of the spray system 1.

If to the first side, the chemical 2 passes out of the storage tank 30 through the first outlet riser 36, through the first storage tank outlet 38, through the first outlet block valve 44, through the first outlet bypass valve 48, through the first pump inlet line 80, into the first pump inlet 102 of first pump 100. Propeller 90 rotates, driving the first pump 100, pushing chemical to the first pump discharge 104, and out to the first nozzle array 120.

If to the second side, the chemical passes out of the storage tank 30 through the second outlet riser 40, through the second storage tank outlet 42, through the second outlet block valve 46, through the first second bypass valve 50 through the second pump inlet line 82, into the second pump inlet 108 of second pump 106. Propeller 90 rotates, driving the first pump 106, pushing chemical to the second pump discharge 110, and out to the second nozzle array 121.

During a rinse operation, the first outlet block valve 44 and/or second outlet block valve 46 are closed, and the associated first outlet bypass valve 48 and/or second outlet bypass valve 50 is moved to a second position. As a result, the pumps 100/106 draw rinse solution 3 from the flush tank 60. The rinse solution 3 passes up the flush riser 65 and into the first flush line 67 and second flush line 68. The flush lines 67/68 connect to the bypass vales 48/50, after which the flow matches that of a dispersal operation. Stated differently, the rinse solution 3 is discharged from the spray nozzles 120/121 just as the chemical 3 is during operation.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction, and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A chemical spray system for use in conjunction with a vehicle, the system comprising:
a storage tank to hold a chemical;
the storage tank within a vehicle;
the storage tank having a storage tank outlet;
the storage tank outlet located at a top of the storage tank;
whereby due to the location of the storage tank outlet, gravity alone cannot cause a chemical to leak out of the storage tank outlet;
an outlet riser within the storage tank;
the outlet riser connecting to the storage tank outlet;
the outlet riser drawing chemical from a bottom of the storage tank;
a pump;
the pump having a pump inlet and a pump outlet;
the pump located outside the vehicle;
the pump powered by rotation of a pump shaft;
an inlet line from the tank to the pump;
the inlet line connecting the storage tank outlet to the pump;
the pump being downstream of the inlet line, resulting in negative pressure within the inlet line during operation of the pump;
a block valve within the inlet line;
the block valve within the vehicle;
the block valve at an elevation higher than the top of the storage tank;
wherein the block valve is located at an elevation above every other part of the chemical spray system;
whereby during operation the chemical flows up in elevation through the outlet riser, through the block valve, down in elevation, through the inlet line and out of the vehicle, and into the pump; and
whereby during operation of the chemical spray system, when the pump is active, the chemical within the vehicle is at negative pressure, thus any leaks are into the chemical spray system, rather than out of the chemical spray system.

2. The chemical spray system of claim 1, wherein the pump is a concentric, self-priming pump;
the self-priming nature of the pump permitting the pump to draw chemical out of the storage tank and through the initially empty inlet line, thereby permitting the inlet line to remain empty until the moment operation is required.

3. The chemical spray system of claim 1, further comprising:
a nozzle array connected to a pump discharge;
the nozzle array formed from one or more nozzles through which chemical is discharged during operation of the chemical spray system.

4. The chemical spray system of claim 1, further comprising:
a propeller that generates rotational motion;
the propeller connected to the pump shaft;
whereby motion of the vehicle causes air to flow across the propeller, thus powering the pump.

5. The chemical spray system of claim 1, further comprising:
a flush tank;
the flush tank storing rinse solution;
the flush tank activated by closing the block valve on the inlet line, and opening a bypass valve, thereby routing flow from the flush tank into the pump;
whereby the rinse solution is used to empty the chemical spray system, downstream of the storage tank, after use.

6. The chemical spray system of claim 4, whereby the propeller rotates at different speeds as the air passing over it changes speed, thus changing the rotational speed of the pump, thereby automatically adjusting the quantity of discharged chemical as the air speed changes.

7. A spray system for use with corrosive chemicals, the spray system mounted to a vehicle, the spray system comprised of:
a vehicle;
a pump to draw chemicals from a storage tank;
the storage tank having connections only above a maximum fill line for chemicals;
the pump outside the vehicle;
the storage tank inside the vehicle;
the storage tank connected to the pump by an inlet line;
a block valve within the inlet line;
the block valve within the vehicle;
the block valve at an elevation higher than a top of the storage tank;
wherein the block valve is located at an elevation above every other part of the chemical spray system;
whereby during operation the pressure within the inlet line is less than atmospheric pressure, thereby preventing leakage of chemicals through breaks in the inlet line and onto the vehicle.

8. The spray system of claim 7, wherein the pump is a concentric, self-priming pump;
the self-priming nature of the pump permitting the pump to draw chemical out of the storage tank and through the initially empty inlet line, thereby permitting the inlet line to remain empty until the moment operation is required.

9. The spray system of claim 7, further comprising:
a nozzle array connected to a pump discharge;
the nozzle array formed from one or more nozzles through which chemical is discharged during operation of the chemical spray system.

10. The spray system of claim 7, further comprising:
a propeller that generates rotational motion;
the propeller connected to a pump shaft;
whereby motion of the vehicle causes air to flow across the propeller, thus powering the pump.

11. The spray system of claim 7, further comprising:
a flush tank;
the flush tank storing rinse solution;
the flush tank activated by closing the block valve on the inlet line, and opening a bypass valve, thereby routing flow from the flush tank into the pump;
whereby the rinse solution is used to empty the chemical spray system, downstream of the storage tank, after use.

12. The chemical spray system of claim 10, whereby the propeller rotates at different speeds as the air passing over it changes speed, thus changing the rotational speed of the pump, thereby automatically adjusting the quantity of discharged chemical as the air speed changes.

13. A chemical spray system that is intrinsically leakproof to prevent damage to a vehicle, the chemical spray system comprising:
a storage section and a dispersal section;
the storage section inside a vehicle;
the dispersal section outside the vehicle;
the storage section including:
a storage tank with top-mounted outlet;
a flush tank;
the dispersal section including:
a pump;
a nozzle array;
the storage section connected to the dispersal section by an inlet line, the inlet line carrying chemical from the storage tank to the pump;
a block valve within the inlet line;
the block valve inside the vehicle;
the block valve at an elevation higher than the top of the storage tank;
wherein the block valve is located at an elevation above every other part of the chemical spray system;
wherein during operation, the pump draws chemical through the inlet line, creating a negative pressure within the inlet line, and thus preventing leaks within the vehicle.

14. The chemical spray system of claim 13, wherein the pump is a concentric, self-priming pump;
the self-priming nature of the pump permitting the pump to draw chemical out of the storage tank and through the initially empty inlet line, thereby permitting the inlet line to remain empty until the moment operation is required.

15. The chemical spray system of claim 13, further comprising:
a nozzle array connected to a pump discharge;
the nozzle array formed from one or more nozzles through which chemical is discharged during operation of the chemical spray system.

16. The chemical spray system of claim 13, further comprising:
a propeller that generates rotational motion;
the propeller connected to a pump shaft;
whereby motion of the vehicle causes air to flow across the propeller, thus powering the pump.

17. The chemical spray system of claim 13, further comprising:
a flush tank;
the flush tank storing rinse solution;
the flush tank activated by closing the block valve on the inlet line, and opening a bypass valve, thereby routing flow from the flush tank into the pump;
whereby the rinse solution is used to empty the chemical spray system, downstream of the storage tank, after use.

18. The chemical spray system of claim 16, whereby the propeller rotates at different speeds as the air passing over it changes speed, thus changing the rotational speed of the pump, thereby automatically adjusting the quantity of discharged chemical as the air speed changes
